(19) United States
(12) Patent Application Publication
(10) Pub. No.: US 2003/0210515 A1
(43) Pub. Date: Nov. 13, 2003

(54) Latch and release mechanism for a panel of a computer hardware device

(76) Inventor: Gilbert Rahmouni, Claix (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/429,254

(22) Filed: May 5, 2003

(30) Foreign Application Priority Data
May 6, 2002 (EP) 02354078.4

(51) Int. Cl. G06F 1/16

(52) U.S. Cl. 361/683; 248/552

(57) ABSTRACT

A latch and release mechanism releasably secures a panel in a computer housing. The mechanism includes a latch member on a panel of the housing and hole on a front chassis segment of the housing. The hole receives the latch member to secure the panel to the body. A release member applies pressure to the latch member to disengage the latch member from the hole and release the panel from the front chassis.

### FIELD OF THE INVENTION

The invention relates to a latch and release mechanism for a panel of a computer hardware device, and in particular although not exclusively to such a mechanism for an access, or front, panel of a personal computer.

### BACKGROUND OF THE INVENTION

Personal computers (PCs) use storage devices, such as floppy disc drives, CDROM drives, DVD drives and hard disk drives, and other modules, which can be upgraded or replaced by the end user. In general these devices are accessible from the front of the PC after removal of a front panel, often referred to as a bezel. The invention relates to a structure for selectively holding and releasing the front panel from the PC.

PCs generally include a main chassis frame, and a front chassis, secured together, and to which is releasably secured the front panel. The most common structure for retaining the front panel in such PCs incorporates a latch and release mechanism as follows. The front panel is molded from plastic with a pair of integral latch members spaced apart adjacent the top of the panel, and a pair of integral spring ribs spaced apart towards the bottom of the panel. Each latch member includes a hook including a ramp surface and an engagement surface. The front surface of the front chassis of the PC has a pair of holes towards the bottom thereof, each hole is for receipt of a spring rib. The upper surface of the front chassis has a pair of spaced apart holes for receipt of the latch members.

To install the front panel the spring ribs are located in the respective holes, and the panel is pivoted upwardly and inwardly such that the ramp surfaces of the latch members contact the front edge of the front chassis and are then forced upwardly, causing bending of the latch members in the process. Each latch member thus rides up over the front chassis until the hook has passed the front edge of the respective hole, thereby enabling the spring bias of the latch member to return the latch member to its initial unbent condition and the hook to fall into the hole. Each engagement surface then engages with the front edge of the respective hole to retain the front panel securely in place. Thus installation of the front panel is a simple process which is also readily achieved by the end user.

To remove the front panel is also in essence simple, but is however not so readily achieved. First, it is not readily apparent to a user of the PC how to release the front panel, as the latch members are very small and not specifically identified in any way. Second, to remove the panel requires each latch member to be lifted up to remove the hook formation from within the respective hole (see FIG. 1), with both being lifted simultaneously, thus permitting the front panel to be pivoted forwardly and downwardly. To lift the latch members using only the fingers of a user is very difficult due to the small access area and the stiff plastic from which the latch members are made. However, to lift both latch members simultaneously using tools is also not readily achieved.

An alternative known in the prior art, and particularly appropriate for tower PCs, is described in U.S. Pat. No. 5,997,115. In this design the latch and release mechanism is secured to the chassis, rather than the front panel, and has a single point where a user must push down to release the front panel. However, to achieve this easier release the mechanism is remarkably complex and thus costly to manufacture. It is also unlikely that the design could be adapted for use in a standard form factor housing rather than tower PCs, due to the greater separation between the latch members in such PCs.

It is an object of the present invention to provide a new and improved access latch and release mechanism for a panel which mitigates the above identified problems.

### SUMMARY OF THE INVENTION

In accordance with one aspect of the invention a computer hardware device comprises a panel having a hook member and body having a first part and a second part. The first part of the body includes a hole for receipt of the hook member and the second part underlies the first part at the location of the hole. A release member is arranged such that pressure applied to a first part of the release member causes a second part of the release member to act on the hook member to disengage the hook member from the hole and release the panel from the body of the computer hardware device. The first part of the release member includes a bearing surface and the second part of the release member includes a contact surface. The release member is pivotally mounted such that pressure applied to the bearing surface pivots the release member and the contact surface pushes the hook member out of the hole. The release member is located between the first and second parts with the bearing surface being visible and accessible to a user through a second hole in the first part.

This latch and release mechanism provides the advantage that the panel can be removed by application of pressure on a readily accessible part of the release member. Depending on the location of the latch and release mechanism the pressure can be applied downwardly or inwardly, but in any event no lifting of any part is required.

Preferably the release member includes a pivot element which fits in a recess in the second part of the body.

Preferably the bearing surface and contact surface are on the upper side of the release member and the pivot element is on the lower side of the release member at a mid point thereof.

The structure of the body of the computer hardware device is typically such that the first part of the body is a front chassis, and the second part of the body is a chassis frame.

Preferably the release member is formed of plastics material of a contrasting color to the body of the computer hardware device and/or the panel.

The panel is preferably formed of plastics material with the latch members integrally molded and the body of the computer hardware device is formed of metal.

According to a second aspect of the invention a computer hardware device has a panel and a body and includes one or more latch and release mechanism (according to the first aspect of the invention) for releasably securing the panel to the body.

### BRIEF DESCRIPTION OF THE DRAWINGS

An example of the present invention will now be described, by way of example only, with reference to the accompanying drawings in which:

FIG. 1, as previously mentioned, is a perspective view of a prior art latch and release mechanism as applied to a standard housing of a PC;

FIG. 2 is a perspective view of a latch and release mechanism of a preferred embodiment of the present invention, as applied to a housing of a PC having a standard form factor;

FIG. 3 is a close up of the relevant portion of the PC illustrated in FIG. 2, showing the latch and release mechanism more clearly;

FIG. 4 is an exploded view of the relevant portion of the PC of FIGS. 2 and 3;

FIG. 5 is a vertical cross sectional view through the latch and release mechanism of the PC of FIGS. 2 to 4, wherein the view is parallel to the front of the PC of FIGS. 2 to 4;

FIG. 6 is a vertical cross sectional view through the latch and release mechanism of the PC of FIGS. 2 to 5, perpendicular to the front of the PC of FIGS. 2 to 5;

FIG. 7 is a perspective view of the inside of the front panel of the PC of FIGS. 2 to 6 showing the parts of the latch and release mechanism; and

FIG. 8 is a perspective view of a release member of the latch and release mechanism of the PC of FIGS. 2 to 7.

### DETAILED DESCRIPTION OF THE PREFERRED EMBODIMENTS

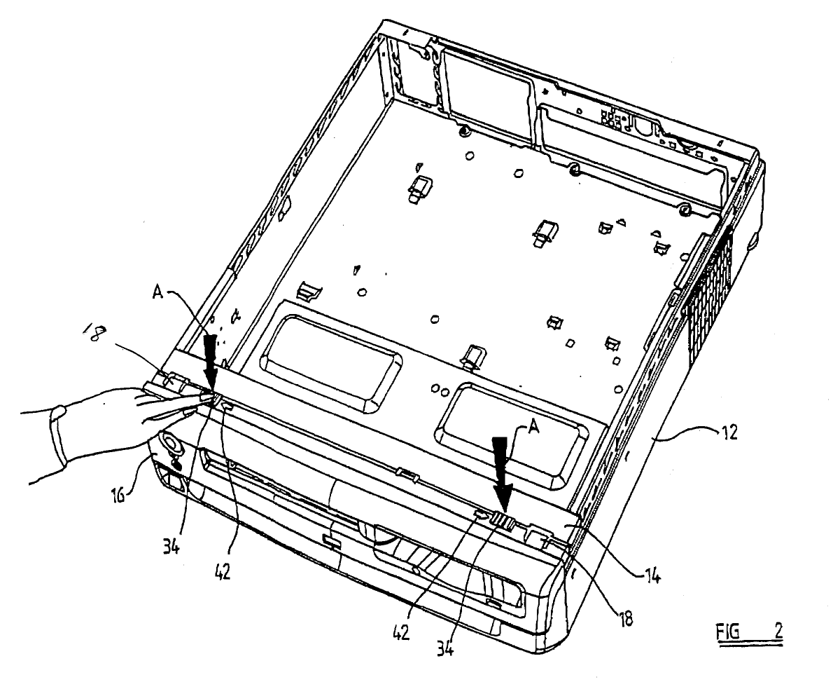

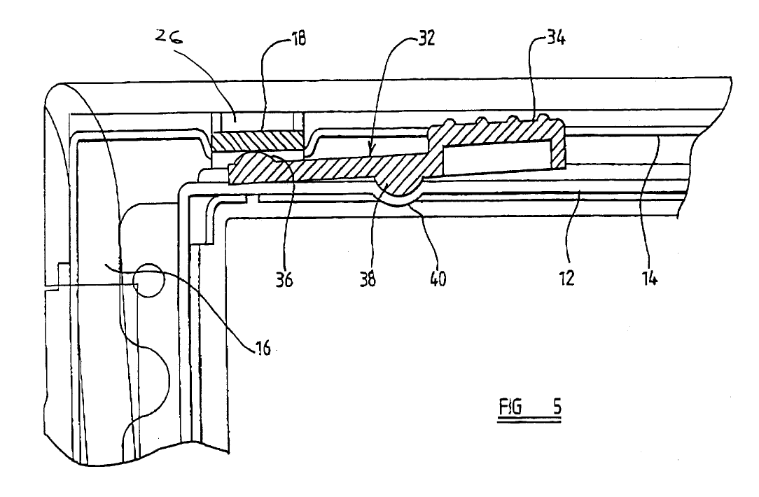

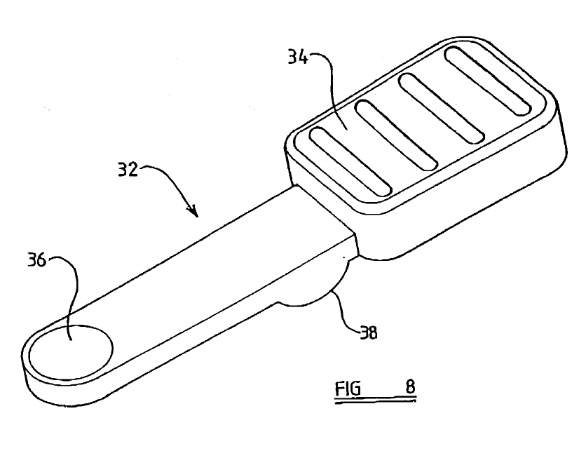

FIGS. 2 to 8 include a latch and release mechanism applied to PC 10 having a housing with a standard form factor. The PC 10 comprises a chassis frame 12 and a front chassis 14 secured together by threaded fasteners to form a chassis, and a front panel 16 releasably secured to the front chassis 14 by means of two pairs of latch and release mechanisms.

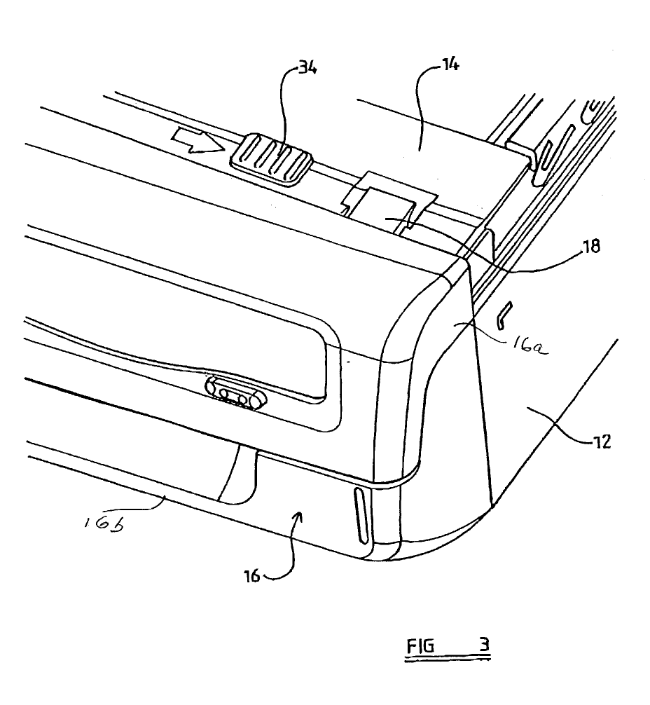

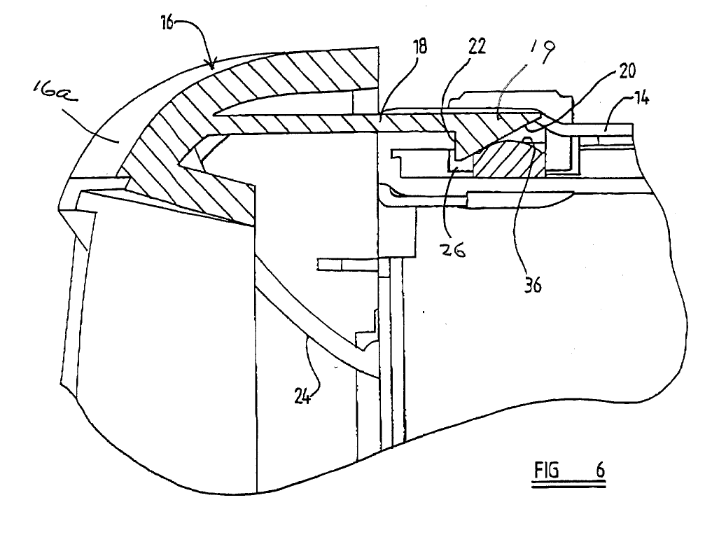

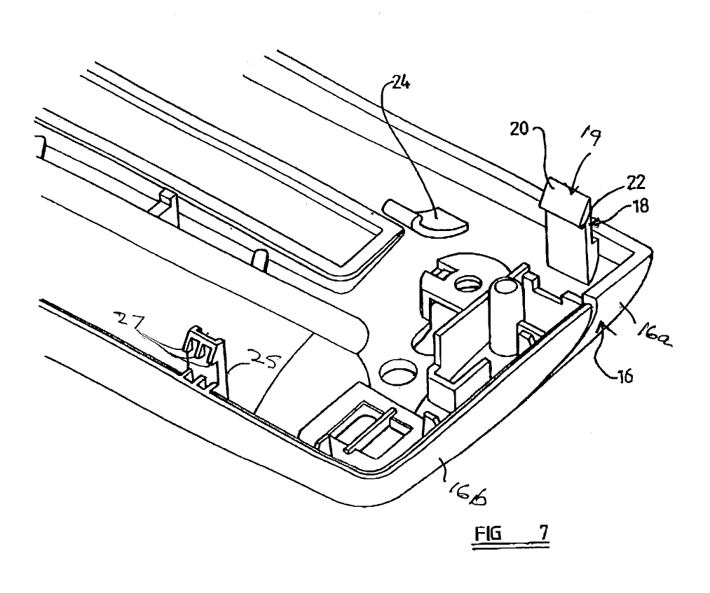

The front panel 16 comprises an upper part 16a and a lower part 16b (FIG. 3). The upper part 16a includes a pair of spaced apart first latch members 18 in proximity to the opposite edges of PC 10. Each of latch members 18 has at its distal end a hook formation (FIGS. 6 and 7) including a ramp surface 20 and an engagement surface 22. Upper front panel part 16a also includes a pair of spaced apart spring ribs 24 (FIGS. 6 and 7) (only one of which is shown) that are in proximity to the edges of PC 10, but inside of hook members 19. Spring ribs 24 serve as location members for front panel 16 relative to front chassis 14. The lower part 16b of the front panel 16 includes a pair of spaced apart second latch members 25 (FIG. 7) (only one shown), each having a downwardly oriented hook formation 27 at its distal end. Latch members 25 are approximately vertically aligned with latch members 18 and assist in properly locating front panel 16 on front chassis 14. First and second parts 16a, 16b of the front panel 16 are molded from plastics material and the latch members 18, 25 and spring ribs 24 arc provided as integral parts of the moldings.

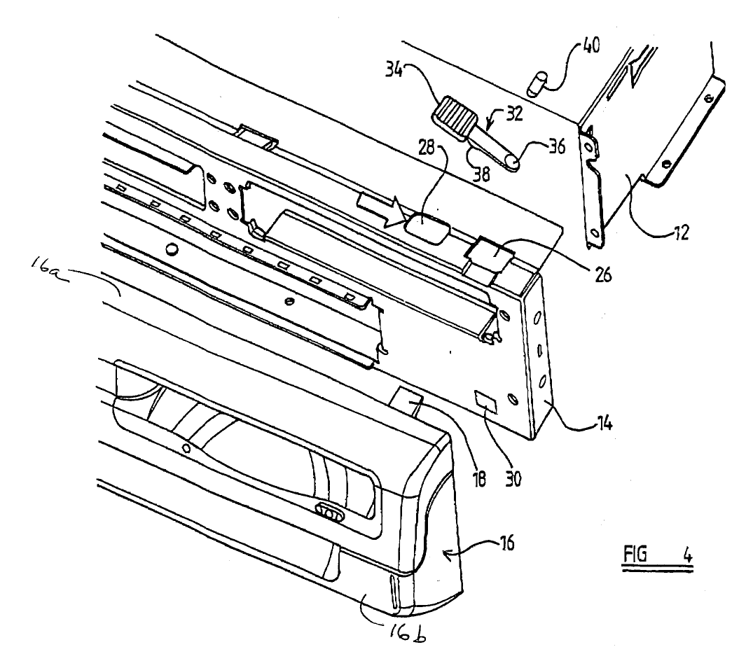

The front chassis 14 includes a first pair of spaced apart holes 26 (FIGS. 4 and 6) (only one shown). Holes 26 are on the upper surface of chassis 14 adjacent the front thereof, and towards the outer edges thereof. The front chassis 14 also includes, on its upper surface and located inwardly of each of the first holes 26, a second pair of spaced apart holes 28 (FIG. 4) (only one shown). Front chassis 14 also includes, on its front surface, towards the bottom thereof, a third pair of spaced part holes 30 (FIG. 4) (only one shown). Holes 30 are conveniently located substantially beneath the first pair of holes 26, and are positioned to receive hooks 27 of latch members 25.

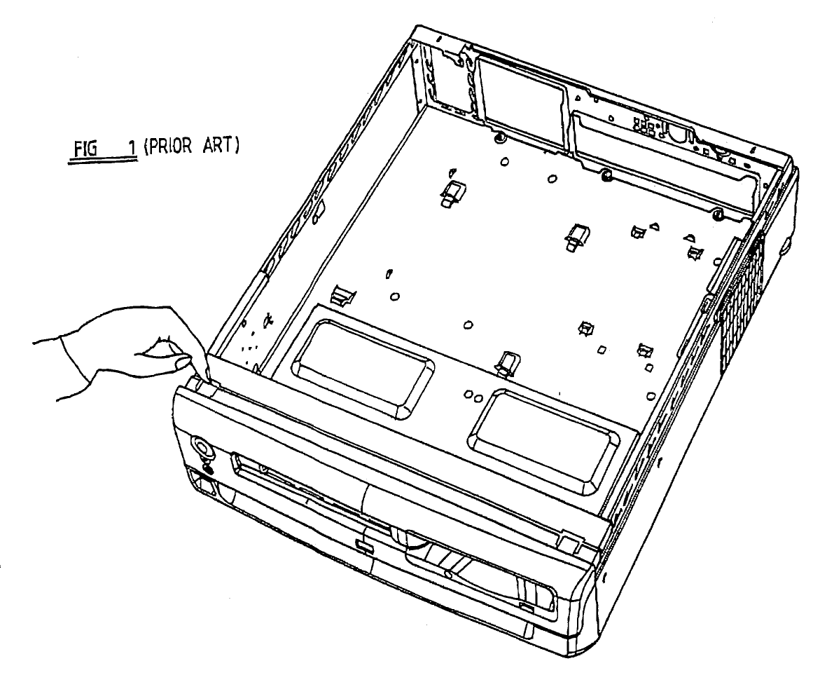

The front panel 16 is secured to the front chassis 14 by placing hooks 27 of second latch members 25 in the third pair of holes 30, and then pivoting the front panel 16 upwardly and inwardly such that the first latch members 18 contact the front edge of the upper surface of the front chassis 14. This action causes the ramp surfaces 20 to ride up and over the upper surface of the front chassis 14, thus bending the first latch members 18 until the hook formations 19 drop into the first holes 26, whereby the first latch members 18 return to their original straight condition. The engagement surfaces 22 then engage the front edge of the holes 26 to prevent the front panel 16 from being removed from the front chassis 14. When the front panel 16 is secured to the front chassis 14 the spring ribs 24 contact the front chassis 14 and create a slight pressure that tends to push chassis 14 from panel 16. This pressure prevents the front panel 16 from rattling and aids in removal of the front panel 16 as described later. This arrangement is substantially as in the prior art of FIG. 1.

Each latch mechanism 18 is associated with a release member 32 (FIGS. 4, 5 and 8). The upper surface at a first end of release member 32 includes a bearing surface 34 which is preferably textured, e.g. ribbed, to prevent a user's finger from slipping when bearing down on surface 34. The upper surface of the other end of release member 32 includes contact surface 36, which is conveniently of domed form. In a mid portion of the release member 32, mid on it's lower surface, is a pivot element 38 conveniently in the form of, a rounded rib running across the release member 32.

Each latch and release mechanism including latch 18 and release member 32 is associated with a pair of recesses 40 (FIG. 4) (only one shown) on the upper surface of the chassis frame 12 adjacent the front thereof. Each of recesses 40 is located between the respective first and second holes 26, 28 in the front chassis 14.

Each release member 32 is located between the upper surface of the front chassis 14 and the upper surface of the chassis frame 12, with the pivot element 38 located in the recess 40. Each bearing surface 34 is located in the respective second hole 28 and the contact surface 36 is located beneath the ramp surface 20 of the respective catch member 18 in first hole 26.

To release the front panel 16 from the body comprising chassis 12 and 14 of the PC 10, the user simply pushes down on each of the bearing surfaces 34, as illustrated by arrows A in FIG. 2. Doing so causes the release members 32 to pivot about the pivot elements 38 such that the first end (where bearing surfaces 34 are located) of each release member 32 moves downwardly towards the chassis frame 12 and the other end of each member 32 (where contact surfaces 36 are located) moves upwards away from the chassis frame 12. Thus the contact surfaces 36 bear up on the ramp surfaces 20 of the first latch members 18, to bend the first latch members 18 and lift the hook formations 19 upwards and out of the first holes 26. The engagement surfaces 22 are thus no longer engaged on the front edges of the holes 26 and the front panel 16 can be pivoted forwardly and downwardly, aided by spring ribs 24, until the hook formations 19 are clear of the front chassis 16, resulting in the first latch members 18 returning to their original straight condition. The second latch members 25 are then removed from the third holes 30 to remove the front panel 16 from the chassis of the PC.

Thus the described latch and release mechanism provides a very simple and user friendly operation for the removal of the front panel of a PC. Furthermore the mechanism is very simple to manufacture, requiring very little modification of the prior art, and thus being cost effective to implement. In particular the front panel 16 requires no modification whatsoever, while all that is required to be changed in the front chassis 14 and chassis frame 12 are the addition of a pair of additional holes 28 and a pair of recesses 40 respectively. As the front chassis 14 and chassis frame 12 are generally made of steel which is formed by pressing from sheet, these minor features are readily added. The only extra components required for the latch and release mechanisms are the release members 32, which are very simple plastic molded parts, and are an identical pair that do not require handling. In addition, the assembly of the PC with the latch and release mechanisms is also very simple and does not require any additional fastenings.

Preferably the release members 32 are molded from plastics material of a contrasting color to that of the other components of the PC against which it is seen in use, in particular the front chassis 14. The contrasting color makes it easier for the user to realize how to remove the front panel 16, and in particular the relevant locations where pressure is to be applied to effect that removal.

Additional assistance for the user is provided by pressing small arrow shapes 42 into the upper surface of the front chassis 14 adjacent to and pointing towards the second holes 28, in order to draw attention to the bearing surfaces 34 of the release members 32 visible through those holes. Such arrows are readily included in the pressing operations involved in forming front chassis 14.

Although the latch and release mechanisms have been described as applied to the front panel of a PC they are clearly also applicable to other computer hardware devices where the end user might require access, such as for example a printer, or indeed to other kinds of electronic equipment.

In alternative applications, latch and release mechanisms as described can be provided in different positions with respect to the computer hardware device. For example, one or two latch and release mechanisms can be located on each side of a computer, rather than a pair on the top. There may also be applications where a single latch and release mechanism as described could be employed.

A further alternative is the provision of the latch members on the chassis, or other body of the computer hardware device, and the provision of the holes or other engagement formations on the panel.

The features disclosed in the foregoing description, or the following claims, or the accompanying drawings, expressed in their specific forms or in terms of a means for performing the disclosed invention, or a method or process for attaining the disclosed result, as appropriate, may, separately, or in any combination of such features, be utilized for realizing the invention in diverse forms thereof.

1. A housing for a computer hardware device comprising:
a panel having a hook member;
a body having a first part and a second part, the first part including a hole for receipt of the hook member, the second part underlying the first part at the location of the hole; and
a release member arranged such that pressure applied to a first part of the release member causes a second part of the release member to act on the hook member for disengaging the hook member from the hole and releasing the panel from the body of the computer hardware device, the first part of the release member including a bearing surface and the second part of the release member including a contact surface, the release member being pivotally mounted such that in response to pressure applied to the bearing surface the release member pivots and the contact surface pushes the hook member out of the hole, the release member being located between the first and second parts with the bearing surface being visible and accessible through a second hole in the first part.

2. A housing according to claim 1 wherein the release member includes a pivot element which is located in a recess in the second part of the body while the panel and body are latched.

3. A housing according to claim 2 wherein the bearing surface and contact surface are on the upper side of the release member and the pivot element is on the lower side of the release member at a mid point thereof.

4. A housing according to claim 1 wherein the first part of the body includes a front chassis and the second part of the body includes a chassis frame.

5. A housing according to claim 1 wherein the release member is formed of plastics material of a contrasting color to the body of at least one of the computer hardware device and the panel.

6. A housing according to claim 1 comprising a location member on the panel and a formation on the body for receipt of the location member, such that the location member fits into the formation while the panel and body are latched.

7. A housing according to claim 1 wherein the panel is formed of plastics material, the hook members being integrally molded to the panel, the body of the computer hardware device being formed of metal.

8. A personal computer comprising:
a panel having a hook member;
a body having a first part and a second part, the first part including a hole for receipt of the hook member, the second part underlying the first part at the location of the hole; and
a release member arranged such that pressure applied to a first part of the release member causes a second part of the release member to act on the hook member for disengaging the hook member from the hole and releasing the panel from the body of the personal computer, the first part of the release member including a bearing surface and the second part of the release member including a contact surface, the release member being pivotally mounted such that in response to pressure applied to the bearing surface the release member pivots and the contact surface pushes the hook member out of the hole, the release member being located between the first and second parts with the bearing surface being visible and accessible through a second hole in the first part.

9. A personal computer according to claim 8 wherein the release member includes a pivot element which is located in a recess in the second part of the body while the panel and body are latched.

10. A personal computer according to claim 9 wherein the bearing surface and contact surface are on the upper side of the release member and the pivot element is on the lower side of the release member at a mid point thereof.

11. A personal computer according to claim 8 wherein the first part of the body includes a front chassis and the second part of the body includes a chassis frame.

12. A personal computer according to claim 8 wherein the release member is formed of plastics material of a contrasting color to the body of at least one of the computer hardware device and the panel.

13. A personal computer according to claim 8 comprising a location member on the panel and a formation on the body for receipt of the location member, such that the location member fits into the formation while the panel and body are latched.

14. A personal computer according to claim 8 wherein the panel is formed of plastics material, the hook members being integrally molded to the panel, the body of the computer hardware device being formed of metal.
